(19) United States
(12) Patent Application Publication
(10) Pub. No.: US 2013/0174642 A1
(43) Pub. Date: Jul. 11, 2013

(54) Micro-Fabricated Chromatograph Column with Sputtered Stationary Phase

(71) Applicant: Pierre Guibal, Morsang Sur Orge (FR)

(72) Inventors: Bertrand Bourlon, La Colle Sur Loup (FR); Pierre Guibal, Morsang Sur Orge (FR)

(21) Appl. No.: 13/806,142

(22) PCT Filed: Mar. 9, 2011
(86) PCT No.: PCT/EP2011/001181

§ 371 Date: Feb. 6, 2013

Related U.S. Application Data
(60) Provisional application No. 61/313,160, filed on Mar. 12, 2010.
(60) Provisional application No. 61/359,991, filed on Jun. 30, 2010.

(51) Int. Cl. G01N 30/60

(52) U.S. Cl. CPC G01N 30/60
USPC 73/23.39; 205/114; 96/105; 210/198.2; 73/61.53

(57) ABSTRACT

A micro-fabricated chromatography column (70) which is particularly well-suited to the surface well-site and/or the downhole analysis of subterranean reservoir fluids in oilfield or gasfield applications (but which may also be used in non-oilfield or non-gasfield situations) is described. This micro-fabricated column integrates a micro-structured substrate (50), such as a silicon substrate, with a stationary phase material (66) deposited by sputtering as a coating in a microchannel (56) in the substrate (50). Benefits of the presently claimed and disclosed inventive concept(s) include enhanced separation of alkanes and isomers, particularly below hexane (i.e., below C6 as well as the separation of carbon dioxide, hydrogen sulfide, and water and other substances present in reservoir fluids, such as natural gas. The chromatography column of the presently claimed and disclosed inventive concept(s) is in one embodiment a part of an entire gas chromatograph system or liquid chromatograph system that in its simplest from also comprises an injector and a detector, preferably the injector, separation column, and detector are all micro-fabricated on a substrate.

### CROSS-REFERENCE TO RELATED APPLICATIONS

The present application is based on and claims priority to U.S. Provisional Application Ser. No. 61/313,160, filed 12 Mar. 2010, and U.S. Provisional Application Ser. No. 61/359,991, filed 30 Jun. 2010, the entirety of each are hereby expressly incorporated herein by reference.

### TECHNICAL FIELD

The present disclosure relates generally to the field of chromatography, and more particularly, but not by way of limitation, to methods of micro-fabricating gas or liquid chromatography separation columns and use of such components in the chromatographic analysis of subterranean reservoir fluids.

### BACKGROUND ART

Chromatography analysis has been used for more than 50 years within the field of oil and gas to separate and quantify the different components/analytes/molecules found within reservoir fluids, such as natural gas and oil. Gas and liquid chromatographs separate mixtures of fluids by virtue of the different retention of their various components on a stationary phase of a separation column. During much of this time period, the technology used within chromatographs has generally remained the same. For example, the equipment used for chromatographs within laboratories has remained fairly large and cumbersome, thereby limiting the adaptability and versatility for the equipment. These limitations may be a strain on resources, as moving the equipment around may be a challenge that requires an unnecessary amount of time and assets. Because of the bulkiness of the existing chromatographic analyzers for fluid analysis, this analysis is typically performed offline/off-site in a laboratory environment. However, within about the past 10 years, certain efforts have been made in reducing the size of chromatography analyzers mainly in applications other than oil and natural gas.

An example of a miniaturized gas chromatograph is disclosed in U.S. Published patent application No. 2006/0210441 A1 to Schmidt (“Schmidt”). This application describes a GC gas analyzer that includes an injector, a separation column, and a detector all combined onto a circuit board (such as a printed circuit board). The injector then incorporates a type of slide valve, which is used to introduce a defined volume of liquid or gas. Schmidt asserts that by using this slide valve, the gas chromatograph may create a reliable and reproducible gas sample. This gas sample is then injected into the column to separate the gas sample into various components.

Though Schmidt describes a smaller gas chromatograph for manufacturing, such chromatographs have still been slow to develop for use within the natural gas industry. For example, there are some gas chromatographs that are manufactured commercially for use within the natural as industry, but these chromatographs are designed specifically for analyzing particular types of natural gas which may comprise only a small portion of the entire spectrum of types of natural gas. Such gas chromatographs are therefore not useful or applicable outside of this narrow application. For example, natural gases that are found within hydrocarbon fields may vary from having only a trace of carbon dioxide to having over 90% carbon dioxide and may comprise various percentages of C1-C6 alkanes. This large variation within the ranges of the components of natural gas makes it difficult for gas chromatographs to correctly separate and analyze the components within the natural gas.

Recently new solutions have been proposed that consist of replacing the lab instrument by an online small sensor. This has now become possible thanks to advances in Micro-Electro-Mechanical-System (MEMS) technologies that enable the building of reproducible devices at the micro-scale.

An example of a miniaturized gas chromatograph which is particularly designed for use in the oil and natural gas industry is taught by European Patent Publication No. 2 065 703 A1 to Guieze (“Guieze”). Guieze teaches a natural gas analyzer which can be disposed on a microchip (such as a silicon microchip) and includes an injector block and at least a first and second column block each of which has a separation column and a detector. The injector block includes a first input to receive composite gas, a second input to receive carrier-gas, and an output to expel the received composite gas and carrier-gas as a gas sample. Each separation column has an input to receive the gas sample, a stationary phase to separate the gas sample into components, and an output to expel the components of the gas sample from the stationary phase. The detector is then arranged to receive the components of the gas sample from the output of the separation column. Further, the injector block and the first and second column blocks are arranged in series on an analytical path of the microchip such that the gas sample expelled by the output of the injector block is received within the first column block. The gas sample is then separated into a resolved component and an unresolved component, in which the unresolved component is expelled by the first column block and received within the second column block. In the method of use of the gas analyzer, the method includes sampling a volume of natural gas with a sampling loop of an injector block to create a gas sample. The gas sample is then injected from the injector block to a first column block using a carrier gas from a reference path. Further, the gas sample may be separated into an unresolved component and a resolved component using a separation column of the first column block.

Standard methods exist for fabricating various MEMS components such as micro-valves and micro-channels in microchips. For example, silicon wafers may be coated with a photoresist material and a desired valve and/or channel pattern may be etched into the wafer using a technique such as Deep Reactive Ion Etching (DRIE). In the case of the fabrication of a MEMS gas chromatography sensor, one of the key components is the fabrication of the micro-column and the stationary phase therein.

More generally speaking, the separation functionality of chromatography columns is enabled by a stationary phase or packing material that coats the inner walls or fills the space inside the column. In the case of natural gas analysis, the stationary phase usually has been based on polydimethylsiloxane (PDMS). Some examples of conventional packing materials used as a solid stationary phase are silica, alumina, molecular sieves, charcoal, graphite and other carbon based materials (“Carbopack”) and porous polymer materials (“Porapak,” “HayeSep”). Silica gel, alumina and charcoal for example have been known for more than 50 years as useful packing materials for the separation of alkanes and non-polar components in chromatography. In practical terms, this consists in a powder packed into the tubes or capillaries constituting classical chromatography columns. Traditionally, these materials have been used to coat or fill macroscopic tubes and capillaries. While there has been an interest from the application and performance standpoint to replace tubes and capillaries with micro-fabricated channels, one of the main issues has been to find a reliable and controlled process to coat or fill uniformly those micro-channels or structures with an appropriate stationary phase or packing material. Indeed the width of the micro-channels can be as low as few tens of microns making it very difficult to pack the micro-channels with stationary phase or pack material. Moreover, the uniformity of the stationary material in the channel (i.e., the uniformity of the thickness of the stationary material in the channel) is usually critical for optimal performance of a chromatographic column.

As noted above, the use of a MEMS gas chromatograph as a component of a natural gas analyzer on a microchip for use downhole in the wellbores of oil and gas wells has been contemplated by Guieze (EP 2 065 703 A1). Other examples of the architecture of self-contained micro-scale MEMS gas chromatographs which are constructed for downhole applications have been described in Shah et al. (U.S. Published Patent Application 2008/0121016) and Shah et al. (U.S. Published Patent Application 2008/0121017).

However, in spite of the progress described above which has been made in the development of micro-scale fluid analysis, MEMS devices which can be used downhole in oil and gas wells, progress in the development of improved stationary phases to be used in the separation columns of the micro-scale chromatography devices, and separation of analytes having molecular masses lower than hexane at a high resolution has lagged behind. It is to rectifying these and other shortcomings of the current technology that the methods and apparatus of the presently claimed and disclosed inventive concept(s) is directed.

### SUMMARY OF THE DISCLOSURE

In view of the foregoing disadvantages, problems, and insufficiencies inherent in the known types of methods, systems and apparatus present in the prior art, exemplary implementations of the present disclosure are directed to apparatus, methods and systems which provide a new and useful micro-scale chromatography separation capability which avoids many of the defects, disadvantages and shortcomings of the prior art mentioned heretofore, and includes many novel features which are not anticipated, rendered obvious, suggested, or even implied by any of the prior art devices or methods, either alone or in any combination thereof. Further, in the description of embodiments herein, numerous specific details are set forth in order to provide a more thorough understanding of the invention, with particular regard to gas chromatography implementations and techniques. However, it will be apparent to one of ordinary skill in the art that the embodiments disclosed herein may be practiced with similar regard to liquid chromatography implementations and techniques (e.g., injection, flow, separation, and the like). In many instances, well-known features of liquid chromatography applications have not been described in detail to avoid unnecessarily complicating the description.

More particularly, at least one aspect of the present disclosure describes a micro-fabricated chromatography column comprising a stationary support phase sputtered on the surfaces of the micro-channels of the column, and a micro-fabricated chromatograph device comprising said column, which is particularly well-suited to the analysis of subterranean reservoir fluids in oilfield or gasfield applications (but which may also be used in non-oilfield or non-gasfield situations). The process for making the column is an alternative solution to other stationary phases or packing materials generally used in separation columns for fluid analysis, and particularly those solutions used in natural gas analysis. This micro-fabricated column integrates a micro-structured substrate, such as a silicon substrate, with a sputtered mineral or carbon-based material as an active nanostructured material comprising the stationary phase of the column. MEMS columns fabricated with this process have been realized herein, with advantageous properties demonstrated for natural gas analysis. The particular benefits of the presently claimed and disclosed inventive concept(s) include enhanced separation of alkanes (including isomers) below hexane (i.e., below C₆), as well as the separation of nitrogen, oxygen, carbon dioxide, hydrogen sulfide, and water and other substances present in reservoir fluids.

The chromatography column of the presently claimed and disclosed inventive concept(s) in at least one embodiment is provided as a part of a completely micro-fabricated chromatograph, which in its simplest form also comprises an injector and a detector. The injector is used to inject a small defined volume of the fluid to be analyzed. This small volume of fluid is carried by a mobile gas or liquid through the separation column where the different analytes are separated and passed to the detector. The detector senses the different analytes exiting the column. The final data may be a chromatogram that is a graph (or other digitized representation of the data) in which the different analytes are seen as detected peaks as a function of time. From the chromatogram, it is possible to quantify the composition of each analyte constituting the analyzed fluid.

The micro-fabricated column contemplated herein is mainly a functionalized or coated microfluidic channel or plurality of channels etched in a substrate (which comprises silicon or other suitable material) and sealed with a glass cover or other material appropriate for bonding. The microfluidic channel is connected to an injector at the inlet and a detector at the outlet. The channel itself can be hollow or include other micro-fabricated structures or pillars (which are directed at providing a more efficient separation of the gas sample by, for example, increasing the surface area within the channel and reducing the diffusion distances between the fluid components and the stationary phase). Typical column length ranges from, but is not limited to, 1-5 cm, 5-10 cm, 10-15 cm, 15-20 cm, 20-30 cm, 30-50 cm, 50-100 cm, to 100-1000 cm. Column height and width can vary, typically, from, but is not limited to, 5-10 μm, 10-20 μm, 20-40 μm, 40-60 μm, 60-80 μm, 80-100 μm, 100-150 μm, 150-250 μm, 250-500 μm, 500-1000 μm, to 1000-5000 μm.

Micro-pillars, where present in the column, may have widths which range from, but are not limited to, 1-5 μm, 5-10 μm, 10-20 μm, 20-40 μm, 40-60 μm, 60-80 μm, to 80-100 μm. The space between the pillars may range from, but is not limited to, 1-5 μm, 5-10 μm, 10-50 μm, 50-100 μm, to 100-500 μm.

Preferably, all surfaces of the inner walls (including the side walls and bottom surface) of the channel or channels of the column (with or without additional micro-structures or pillars) are coated with one or more layers of a mineral or carbon-based material which has been sputtered onto the surfaces. The coatings typically have a thickness of from less than one nm to a few nm, to a few tens of nm, to a few hundreds of nm, to a few thousands of nm.

This sputtered coating material is preferably substantially uniformly deposited (as described in more detail below) along the length of and inside the micro-channels of the micro-column using a process compatible with large scale “wafer-level” production at industrial facilities. The sputtered material in several embodiments may comprise one or more layers of silica, alumina, and/or graphite deposited by sputtering. The choice of experimental parameters such as temperature, pressure, power level, duration of deposition time, rate of deposition, gases used during the sputtering process, or the material used, may be varied depending on the type and thickness of stationary phase desired.

According to an aspect of the present disclosure the presently claimed and disclosed inventive concept(s) is directed to a method for micro-fabricating a MEMS chromatography channel, comprising the steps of: providing a substrate, preparing and etching a surface of the substrate to form an etched substrate having a fluid micro-channel, sputtering a layer of a stationary phase material on a wall surface of the fluid micro-channel, wherein the layer of the stationary phase material is substantially uniform in thickness along the length of the fluid micro-channel, and the formation of contaminates on the surface of the etched substrate is minimized, and disposing a cover over at least a portion of the surface of the etched substrate for enclosing at least a portion of the fluid micro-channel having the stationary phase layer. The step of preparing and etching may further comprise applying a photoresist material upon the surface of the substrate, removing a portion of the photoresist material using photolithography, and etching the fluid micro-channel in the substrate using a deep reactive ion etching process. Further, in the step of sputtering the layer of stationary phase, the material sputtered may be, for example, silica, alumina, or graphite, or combinations thereof. Also, the substrate used in the method may comprise silicon, sapphire, gallium arsenide, a Group III-IV material, and may be doped or undoped, for example. At least a portion of the fluid micro-channel is preferably enclosed using a glass cover such as a Pyrex glass wafer, and/or a cover constructed from silicon, or a metal or metallized cover.

In another aspect of the present disclosure, the presently claimed and disclosed inventive concept(s) is directed to a micro-scale chromatograph for separating components of a fluid, such as natural gas, comprising an injector block for providing a fluid sample for separation into a plurality of components, a separation column for receiving the fluid sample, the separation column having an input to receive the fluid sample, a stationary phase comprised material sputtered upon a fluid micro-channel in the separation column in a substantially uniform layer along the length of the fluid micro-channel, and an output through which is expelled the components of the fluid sample, and a detector arranged to receive the components of the fluid sample from the output of the separation column. The separation column is etched into a substrate which may be silicon-based for example. The separation column preferably has a micro-channel length of at least 0.5 m, though it may have a length of as little as 1 cm. The micro-scale chromatograph is preferably adapted for use on a well-site at or near a wellhead of a wellbore.

In another aspect of the present disclosure, the presently claimed and disclosed inventive concept(s) is directed to a method for analyzing a fluid sample (preferably a natural gas sample) comprising a plurality of analytes having molecular masses lower than hexane. The method includes the steps of providing a micro-scale chromatograph such as described above, injecting the fluid sample into the micro-scale chromatograph wherein at least a portion of the plurality of analytes are separated by the sputtered stationary phase in the separation column of the micro-scale chromatograph, and detecting the portion of the plurality of analytes separated by the separation column as a function of time. Preferably the portion of the plurality of analytes separated by the separation column comprises at least two of methane, ethane, propane, butane, a pentane, carbon dioxide, and hydrogen sulfide. The fluid sample may be analyzed at a surface by positioning the micro-scale chromatograph in fluid communication with a sampling apparatus and/or a separator apparatus wherein the fluid sample is obtained from the fluid formation adjacent the wellbore. Or, the fluid sample may be analyzed downhole by disposing the micro-scale chromatograph within a wellbore and the fluid sample is obtained from a fluid formation adjacent the wellbore. Preferably, the analytes separated in the separation column are separated by a resolution factor R>1.5. Further, the stationary phase of the separation column may be heated by a heating element disposed in or adjacent the substrate of the separation column.

In another aspect, the present disclosure is directed to a downhole tool for analyzing a fluid sample in a wellbore, the downhole tool comprising a housing operatively connected to a conveyable line, a micro-scale chromatograph as described above which is positioned in the housing, and a communication link providing an operative communication between the microscale chromatograph of the downhole tool and a power assembly. The downhole tool may be a drilling tool, a wireline tool, a tool string, a bottomhole assembly, or a well survey apparatus.

These together with other aspects, features, and advantages of the present disclosure, along with the various features of novelty, which characterize the presently claimed and disclosed inventive concept(s), are pointed out with particularity in the claims annexed to and forming a part of this disclosure. The above aspects and advantages are neither exhaustive nor individually or jointly critical to the spirit or practice of the disclosure. Other aspects, features, and advantages of the present disclosure will become readily apparent to those skilled in the art from the following description of exemplary embodiments and description in combination with the accompanying drawings. Accordingly, the drawings and description are to be regarded as illustrative in nature, and not restrictive.

### BRIEF DESCRIPTION OF THE DRAWINGS

Various aspects and embodiments of the presently claimed and disclosed inventive concept(s) are described below in the appended drawings to assist those of ordinary skill in the relevant art in making and using the subject matter hereof. In reference to the appended drawings, which are not intended to be drawn to scale, like reference numerals are intended to refer to identical or similar elements. For purposes of clarity, not every component may be labeled in every drawing.

FIG. 1A is a schematic representation in cross-section of a wellhead sampling unit and chromatograph system of the presently claimed and disclosed inventive concept(s) in an exemplary operating environment.

FIG. 1B is a schematic representation of one embodiment of a sampling unit and chromatograph system for downhole analysis of formation fluids according to the presently claimed and disclosed inventive concept(s) with an exemplary borehole tool deployed in a wellbore.

FIG. 2 is a perspective view of components of a micro-fabricated chromatography apparatus according to an embodiment of the presently claimed and disclosed inventive concept(s).

FIG. 3 represents a cross-sectional schematic view of a process of fabrication of a sputter-coated column on a substrate, (A) deposition on the substrate of a photoresist material by spin coating, (B) photolithography and etching of micro-channels by DRIE, (C) sputtering of a stationary phase material on the micro-channel and remaining photoresist material, (D) lift-off of the remaining photoresist material and sputtered material deposited on the photoresist material, (E) silicon-Pyrex anodic bonding to seal the sputter-coated micro-channels.

FIG. 4 shows SEM photomicrographs of micro-fabricated column micro-channels coated with sputtered silica, (A) general top plan view of part of a micro-fabricated column with silica coating (appearing as white), (B) further magnified view of coated micro-channel wall showing that silica is deposited on both vertical and horizontal surfaces, (C) zoom in a MEMS micro-channel having silicon micro-pillars, (D) side view zoom on silica-sputtered micro-pillars. Silica appears in white color.

FIG. 5 is a photograph of a sputtered silica micro-fabricated separation column of the presently claimed and disclosed inventive concept(s). The total size is several cm².

FIG. 6 is a chromatogram of the separation of a methane/ethane/propane/CO₂ mixture using a sputtered silica coated micro-fabricated separation column of the presently claimed and disclosed inventive concept(s).

FIG. 7 is a chromatogram of the separation of an O₂/N₂—CO₂ mixture using a sputtered silica coated micro-fabricated separation column of the presently claimed and disclosed inventive concept(s).

FIG. 8 is a block diagram illustrating one embodiment of a chromatography system according to the presently claimed and disclosed inventive concept(s).

FIG. 9A is a block diagram of one example of component layout for a chromatography apparatus according to aspects of the presently claimed and disclosed inventive concept(s).

FIG. 9B is a block diagram of another example of component layout for a chromatography apparatus according to aspects of the presently claimed and disclosed inventive concept(s).

FIG. 9C is a block diagram of another example of component layout for a chromatography apparatus according to aspects of the presently claimed and disclosed inventive concept(s).

FIG. 10 is a block diagram of another embodiment of a chromatography system according to the presently claimed and disclosed inventive concept(s).

FIG. 11 is a top view of a schematic of one embodiment of a chromatography column according to an embodiment of the presently claimed and disclosed inventive concept(s).

FIG. 12 is a cross-sectional view of an alternate embodiment of a chromatography column of the presently claimed and disclosed inventive concept(s).

### DESCRIPTION OF EXEMPLARY EMBODIMENTS

Specific embodiments of the present disclosure will now be described in detail including reference to the accompanying figures. Like elements in the various figures may be denoted by like reference numerals for consistency.

Examples of specific implementations are provided herein for illustrative purposes only and are not intended to be limiting. In particular, acts, elements and features discussed in connection with one embodiment are not intended to be excluded from a similar role in other embodiments.

In the following detailed description, numerous specific details are set forth in order to provide a more thorough understanding of the disclosure. However, it will be apparent to a person having ordinary skill in the art that the present disclosure may be practiced without these specific details. In other instances, features which are well known to persons of ordinary skill in the art have not been described in detail to avoid complicating unnecessarily the description.

Also, the phraseology and terminology used herein is for the purpose of description and should not be regarded as limiting. The use of “including,” “comprising,” “having,” “containing,” “involving,” and variations thereof herein, is meant to be broad and to encompass the items listed thereafter and equivalents thereof as well as additional subject matter not recited.

Further, in this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

Chromatographs, used in both gas and liquid phase chromatography, rely on discrete hollow columns or channels which contain a stationary support material for separation of fluids passing therethrough, particularly complex mixtures of gases and/or liquids. Gas chromatography has been used for decades for natural gas analysis. Likewise, liquid chromatography has been used for decades for analysis of liquid fossil fuels, oilfield chemicals, and liquids saturated with oil. Generally, the fluid to analyze is sampled and brought to a lab. Recently new solutions have been proposed that involve replacing lab instruments by in line small autonomous sensors. This approach has been helped by advances in MEMS technologies that enable miniaturization and production of devices at the micro-scale. In the case of fabricating a MEMS chromatography sensor, one of the key components is the MEMS column. The purpose of a chromatography column is to separate the different analytes carried by a mobile fluid (e.g., helium, hydrogen, alcohols, polar and non-polar solvents, and the like).

The separation functionality of chromatography columns is enabled by a stationary phase or packing material that coats the inner walls or fills the space inside the column. In the case of natural gas analysis, wall coated columns can be based on polydimethylsiloxane (PDMS), and packed columns generally use molecular sieves, carbon-based materials or porous polymer materials.

While there is an interest from the application and performance standpoint to replace tubes and capillaries with microfabricated columns, one of the main issues has been to find a reliable and controlled process to coat or fill uniformly those micro-channels or structures with an appropriate stationary phase or packing material. Indeed the width of the micro-channels can be as low as few tens of microns. Moreover, the uniformity of the deposition is usually important for the optimal performance of a chromatography column.

Sputtering is a technique which has been used for the deposition of thin films onto a substrate (generally a Si wafer). There are different kinds of deposition methods (including, but not limited to, DC, RF, and magnetron). The general principle comprises the ionization of a gas between the substrate and a target material inside a chamber. Ions thus generated are accelerated towards the target that is made of the material to be deposited. Collisions of ions with the target material induce ejection of target atoms from the target material and finally deposition of those target atoms onto the substrate.

This disclosure demonstrates the novel use of the sputtering technique for the fabrication of efficient MEMS chromatography columns wherein mineral or carbonaceous materials are deposited by sputtering onto micro-channels of a micro-column, which can be used to replace conventional stationary phases used for packed or open tubular chromatography columns. The process described herein allows the efficient production of MEMS chromatographic columns at a wafer (substrate) level (compatible with mass production). Deposition by sputtering of various materials such as, but not limited to, carbon based materials such as graphite and amorphous carbon, silica, alumina, zeolites, aluminosilicates, organic adsorbents, porous polymers (e.g., styrene-divinylbenzene copolymers and polydimethylsiloxane), salts, hydroxides, and metallic complexes as a stationary phase are contemplated herein. The separation of methane, ethane, carbon dioxide, propane and O₂/N₂ is demonstrated for example.

The presently claimed and disclosed inventive concept(s), as described in further detail below, is directed to such chromatographic columns and apparatus, and chromatographs containing them, and methods of their use, in these embodiments, as well as others, and to methods of their production as discussed further herein. Embodiments of the presently claimed and disclosed inventive concept(s) and aspects thereof are therefore directed to a gas or liquid chromatography apparatus and system that incorporates micro-scale components, partially, or completely. In particular the presently claimed and disclosed inventive concept(s) is directed to a column having a stationary phase comprising a material (such as is described above) which has been sputtered onto an inner surface of the column, and is suitable for use in a variety of environments. Traditionally, chromatographic analysis is performed above the borehole, on the surface of the earth, usually in a laboratory or similar environment. A sample may be collected at a remote location or sample site, for example, an underground or underwater location, and then returned to a testing facility, such as a laboratory, for chromatographic analysis. As discussed above, although there have been some developments of portable chromatography systems, few have been suitable for “on-site” applications at or near the wellhead. Therefore, to address these and other limitations in the prior art, aspects and embodiments of the presently claimed and disclosed inventive concept(s) are directed to a chromatography system having an architecture that allows for operation at or near the wellhead, or even downhole in the wellbore. In a preferred embodiment of the presently claimed and disclosed inventive concept(s), the chromatograph is a MEMS device completely micro-fabricated on a substrate, such as a wafer, and is associated with a sampling device at the surface of the borehole (although components thereof may be downhole).

According to one embodiment, a chromatography system of the presently claimed and disclosed inventive concept(s) that includes MEMS components may be arranged in a tubular housing, the housing having as small an outer diameter as feasible, and as contemplated herein are well-suited to downhole applications. For example, boreholes are typically small diameter holes having a diameter of approximately 5 inches or less. In addition, high temperature and high pressure are generally experienced in downhole environments. Therefore, the components of and/or housing of the apparatus of the presently claimed and disclosed inventive concept(s) are able to accommodate these conditions. For example, in one embodiment, a chromatography apparatus may include various thermal management components. In addition, a surface-located, or downhole-located, chromatography apparatus according to embodiments of the presently claimed and disclosed inventive concept(s) may be a self-contained unit including an on-board supply of carrier fluid and on-board waste management containers and systems. These and other features and aspects of the chromatography apparatus according to embodiments the presently claimed and disclosed inventive concept(s) are discussed in more detail below with reference to the accompanying description of the drawings.

Further, it is to be appreciated that this presently claimed and disclosed inventive concept(s) is not limited in its application to the details of construction and the arrangement of components set forth in the following description, embodiments, examples or as illustrated in the drawings. The presently claimed and disclosed inventive concept(s) is capable of other embodiments and of being practiced or of being carried out in various ways. For example, it is to be appreciated that the chromatography apparatus described herein is not limited to use with or in boreholes (aboveground, or belowground) or other gasfield or oilfield situations and may be used in a variety of environments and application such as, for example, other underground applications, underwater and/or space applications or any application where it is desirable to have a micro-scale chromatograph, such as in an underground mine, a gas or oil pipeline, or in a residential or commercial building or structure (e.g., a basement or crawlway). For example, the chromatograph the presently claimed and disclosed inventive concept(s) may be designed and constructed in such a manner as to be sized so that an individual person or animal can carry the unit for use in circumstances where the ability to use a heretofore chromatograph is desirable but is not feasible or possible due to the size and bulkiness of chromatographic units.

As indicated above, the apparatus of the presently claimed and disclosed inventive concept(s) may be used in association with a wellbore. Wellbores are drilled to locate and produce hydrocarbons. A downhole drilling tool with a bit at an end thereof is advanced into the ground to form a wellbore. As the drilling tool is advanced, a drilling mud is pumped from a surface mud pit, through the drilling tool and out the drill bit to cool the drilling tool and carry away cuttings. The fluid exits the drill bit and flows back up to the surface for recirculation through the tool. The drilling mud is also used to form a mudcake to line the wellbore.

Fluids, such as oil, gas and water, are commonly recovered from subterranean formations below the earth's surface. Drilling rigs at the surface are often used to bore long, slender wellbores into the earth's crust to the location of the subsurface fluid deposits to establish fluid communication with the surface through the drilled wellbore. The location of subsurface fluid deposits may not be located directly (vertically downward) below the drilling rig surface location. A wellbore which defines a path which deviates from vertical to some laterally displaced location is called a directional wellbore. Downhole drilling equipment may be used to directionally steer the wellbore to known or suspected fluid deposits using directional drilling techniques to laterally displace the borehole and create a directional wellbore. The path of a wellbore, or its “trajectory,” is made up of a series of positions at various points along the wellbore obtained by using known calculation methods.

The drilled trajectory of a wellbore is estimated by the use of a wellbore or directional survey. A wellbore survey is made up of a collection or “set” of survey-stations. A survey station is generated by taking measurements used for estimation of the position and/or wellbore orientation at a single position in the wellbore. The act of performing these measurements and generating the survey stations is termed “surveying the wellbore.”

Surveying of a wellbore is often performed by inserting one or more survey instruments into a bottomhole assembly (BHA), and moving the BHA into or out of the wellbore. At selected intervals, usually about every 30 to 90 feet (approximately 10 to 30 meters), the BHA, having the instruments therein, is stopped so that measurement can be made for the generation of a survey station. Therefore, it is also contemplated herein that the presently claimed and disclosed inventive concept(s) may comprise a component or instrument of such a BHA.

Directional surveys may also be performed using wireline tools. Wireline tools are provided with one or more survey probes suspended by a cable and raised and lowered into and out of a wellbore. In such a system, the survey stations are generated in any of the previously mentioned surveying modes to create the survey. Often wireline tools are used to survey well bores after a drilling tool has drilled a well bore and a survey has been previously performed. The micro-scale chromatograph the presently claimed and disclosed inventive concept(s) may thus comprise, in an alternate embodiment, a component of such a wireline tool, as well as of a BHA, for example, and indeed may also comprise a component of a downhole drilling tool used to drill a wellbore.

As disclosed herein, certain embodiments are generally described for separating components from a gas sample such as a sample of natural gas. Those having ordinary skill in the art will appreciate that any composite, whether gas, liquid, or a mixture of both, known in the art, and not only natural gas, may be used to be separated into smaller components in accordance with embodiments disclosed herein.

Embodiments disclosed herein, as noted previously, relate to a fluid analyzer that is, in a preferred embodiment, at least partially (or completely) disposed or formed upon a substrate such as a silicon-based substrate, for example a microchip. The substrate upon which the fluid analyzer and/or separation column component is disposed, formed, or otherwise constructed (which may also be referred to herein as a “wafer”) can be constructed, for example, of silicon, glass, sapphire, or various types of other materials, such as gallium arsenide, or a Group III-IV material. The substrate can either be doped or undoped and can be provided with a variety of orientations such as <1-0-0>, <1-1-0>, or <1-1-1>. The fluid analyzer may be connected to a sampler located at a wellhead to provide a fluid sample (preferably a natural gas sample) from a wellbore and to a carrier fluid source for providing a carrier fluid, and includes an injector block and one or more microfabricated column blocks. The injector block of the fluid analyzer is used to create a fluid sample from the fluid, and then uses the carrier fluid to carry the fluid sample through the remainder of the fluid analyzer (i.e., the column block). As the sample is received within the one or more column blocks, the fluid sample is separated into at least two components. These components may then be eluted from the fluid analyzer, or the components may be passed onto other column blocks for further separation or detection. Preferably the injector, separation column, and detector are all micro-fabricated.

As noted, because this fluid analyzer is preferably disposed at least partially upon a substrate such as a silicon-based microchip, embodiments disclosed herein may comprise a valve, such as a microvalve, that may be incorporated into the fluid analyzer. The valve may be machined into the substrate, and may further comprise a flexible membrane, and a rigid membrane substrate. In one embodiment, a loop groove and a conduit are machined or formed onto the substrate, and the flexible membrane or substrate is disposed over the substrate and the rigid membrane is disposed on top of the flexible membrane. The conduit is formed in a way such that pressure may be used to push the flexible membrane to open and close the conduit. As the conduit then opens and closes, fluid flowing through the conduit may pass through or be impeded, thereby opening and closing the valve to enter the micro-fabricated column comprising the sputtered stationary phase contemplated herein.

As mentioned above, the micro-scale fluid analyzer contemplated herein may comprise multiple column blocks for separating the fluid sample into different components. Natural gas, as contemplated herein, is any gas produced from oil or gas reservoirs from exploration to production, generally has many components, the main components being nitrogen, carbon dioxide, hydrogen sulfide, methane, and various other alkanes particularly C₂-C₆ alkanes. To separate these various components of the natural gas from one another, it may be desired to have several micro-scale column blocks with various separation columns for use in parallel or within a series. Further, though oxygen is not naturally present within natural gas, oxygen may still contaminate the natural gas source and/or the fluid sample. Therefore, oxygen may be another component of interest to be identified in the fluid sample. Because of the various components present within the fluid sample, a preferred carrier fluid used within the embodiments directed to gas chromatography applications disclosed herein is helium. Helium already has a high mobility, in addition to generally not being a component of a gas sample comprising natural gas, so this may help avoid complications when separating the components of the gas sample. However, those having ordinary skill in the art will appreciate that the presently claimed and disclosed inventive concept(s) is not limited to only the use of helium as a carrier fluid, and other gases such as nitrogen, argon, hydrogen, air, and other carrier fluids known in the art may be used.

Further still, a thermal conductivity detector (TCD) may be used for the detector to detect and differentiate between the separated components of the fluid sample. Recent developments in technology have significantly decreased the sizes of TCDs, such as by micro-machining the TCDs, while still allowing for very accurate readings. Fluid analyzers, specifically designed for detection of natural gas components with these TCDs, may be very small, but still capable of detecting traces of gases, such as down to a few parts-per-million (ppm) or parts-per-billion (ppb). However, those having ordinary skill in the art will appreciate the presently claimed and disclosed inventive concept(s) is not so limited, and any detectors known in the art, such as flame ionization detectors (FIDs), electron capture detectors (ECDs), flame photometric detectors (FPDs), photo-ionization detectors (PIDs), nitrogen phosphorus detectors (NPDs), HALL electrolytic conductivity detectors, (UVDs) UV-Visible detectors, (RIDs) refractive index detectors, (FDs) fluorescence detectors, (DADs) diode array detectors, and (IRDs) infrared detectors may be used without departing from the scope of the presently claimed and disclosed inventive concept(s). Each of these detectors may then include an electronic controller and signal amplifier when used within the fluid analyzer.

As noted above, in accordance with embodiments disclosed herein, to improve the versatility of the fluid analyzer, and/or the sputtered separation column, the fluid analyzer may be machined (e.g., micro-machined) or formed onto a substrate, such as a silicon microchip (or other microchip or wafer described elsewhere herein), such that the fluid analyzer includes a chromatograph as a (micro-fabricated) micro-electro-mechanical system (MEMS). As such, a sampling loop, the one or more separation columns, and each of the valves, where present, of the fluid analyzer may be formed onto the substrate. Further, due to the properties of reservoir fluids and the components included therein, the substrate of the fluid analyzer contemplated herein preferably is formed from a material that is resistant to sour gases. For example, the substrate of the fluid analyzer may be formed from silicon, which is chemically inert to the sour gas components of natural gas, such as carbon dioxide and hydrogen sulfide. Similar to the substrate, preferably the flexible membranes and the rigid substrate or membrane of the micro-valve, where present, are formed from materials inert to the sour gas components of natural gas. For example, the flexible membranes may be formed from a polymer film, such as PEEK polymer film available from VICTREX, or any other flexible membrane known in the art, and the rigid substrate or membrane may be formed from glass, or any other rigid substrate known in the art.

The terms “column,” “channel,” “chromatography column,” “micro-channel,” and variations thereof, are used interchangeably herein to refer to the separation column or components thereof comprising the material sputtered therein or thereon.

The term “functional group” refers to groups of atoms that give the compound or substance to which they are linked characteristic chemical and physical properties. A “functionalized” surface refers to a sputtered coating as described herein on which chemical groups are adsorbed or chemically attached. The term “aggregate” refers to a dense, microscopic particulate structure comprising a sputtered material of the invention. The term “micropore” refers to a pore within the sputtered material which has a diameter of less than 2 nanometers. The term “mesopore” refers to pores having a cross-section greater than 2 nanometers and less than 50 nanometers. The term “surface area” refers to the total surface area of a substance measurable by the BET technique. The term “accessible surface area” refers to that surface area not attributed to micropores (i.e., pores having diameters or cross-sections less than 2 nm).

As noted above, in a preferred embodiment the micro-scale chromatograph is operated at the wellbore surface. However, in another embodiment, the micro-scale chromatograph and separation column of the presently claimed and disclosed inventive concept(s) is a component of a downhole tool which may be lowered through a tubing positioned within a gas well or oil well wellbore which is lined with a casing. Preferably a packer is positioned between the tubing and the casing to isolate the tubing-casing annulus. The downhole tool is run on a carrier which may be a wireline, slickline, tubing or other carrier, and which may include one or more electrical conductors for carrying power or signals to the components of the downhole tool.

The wellhead-disposed, surface-disposed, or downhole device may comprise other components known in the art. For example, the fluid analyzer of the presently claimed and disclosed inventive concept(s) may comprise switches which include microelectromechanical elements, which may be based on microelectromechanical system (MEMS) technology. MEMS elements include mechanical elements which are movable by an input energy (electrical energy or other type of energy). MEMS switches, as noted earlier, may be formed with micro-fabrication techniques, which may include micromachining on a semiconductor substrate (e.g., silicon substrate). In the micromachining process, various etching and patterning steps may be used to form the desired micromechanical parts. Some advantages of MEMS elements are that they occupy a small space, require relatively low power, are relatively rugged, and may be relatively inexpensive.

Switches according to other embodiments may be made with microelectronic techniques similar to those used to fabricate integrated circuit devices. As used here, switches formed with MEMS or other microelectronics technology may be generally referred to as “micro-switches.” Elements in such micro-switches may be referred to as “micro-elements,” which are generally elements formed of MEMS or microelectronics technology. Generally, switches or devices implemented with MEMS technology may be referred to as “microelectromechanical switches.”

In one embodiment, micro-switches may be integrated with other components. As used here, components are referred to as being “integrated” if they are formed on a common support structure placed in packaging of relatively small size, or otherwise assembled in close proximity to one another. Thus, for example, a micro-switch may be fabricated on the same support structure (substrate) as the separation column, injector, and/or detector.

Reference is now made to the drawings, illustrations, pictures and descriptions below which are exemplary, but not limiting, the presently claimed and disclosed inventive concept(s).

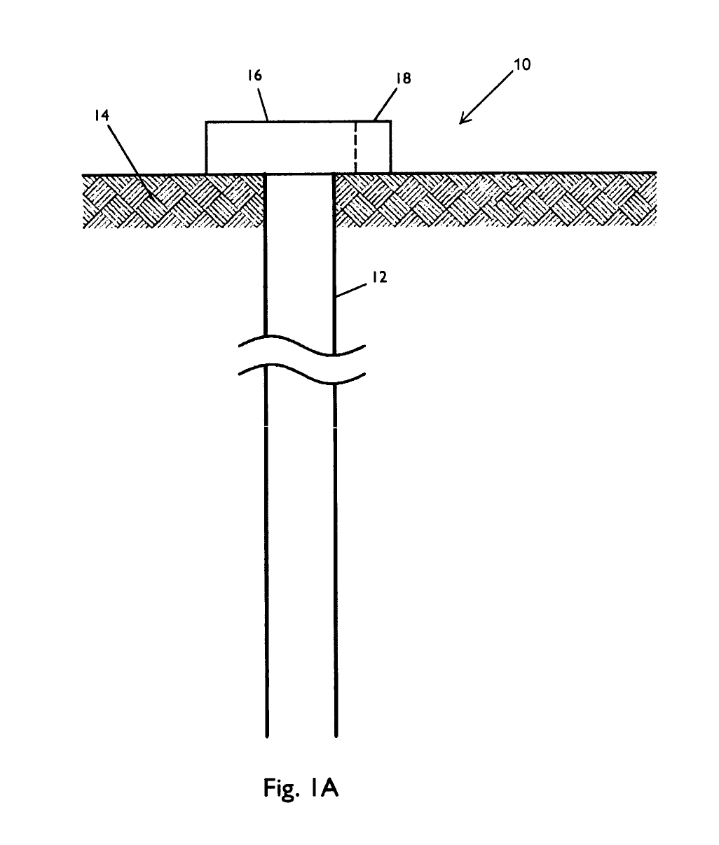

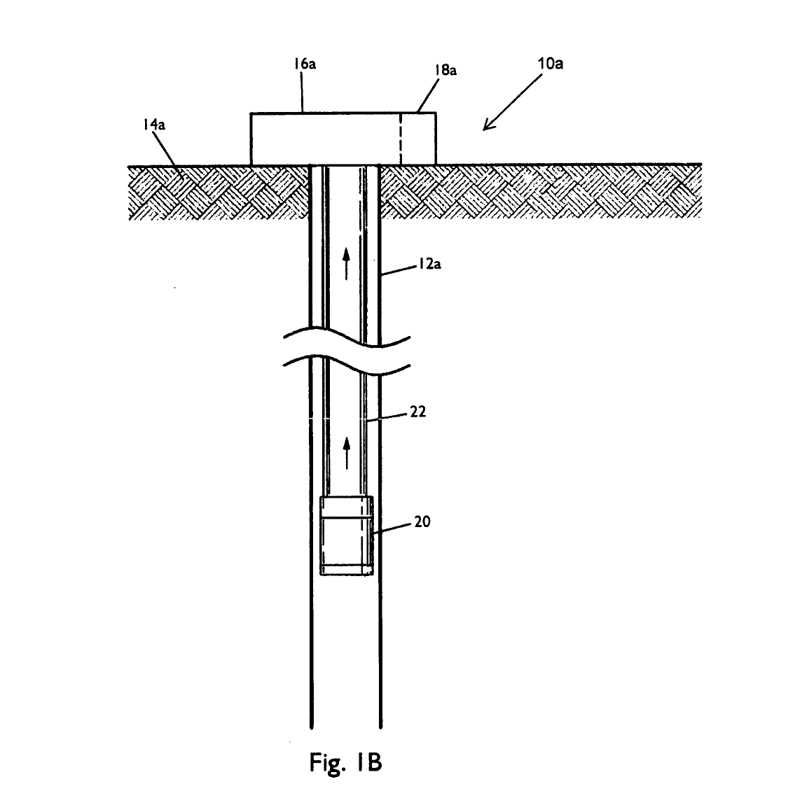

FIG. 1A is a schematic representation in cross-section of an exemplary operating environment of the presently claimed and disclosed inventive concept(s) comprising a well-site 10 having a borehole (or wellbore) 12 drilled into a geologic formation 14. FIG. 1A further depicts a fluid sampling system 16 and a fluid analyzer 18 of the presently claimed and disclosed inventive concept(s) positioned at the wellhead.

FIG. 1B is an exemplary embodiment comprising a well-site 10a having a borehole 12a drilled into a geologic formation 14a. A fluid sampling system 16a is associated with a fluid analyzer 18a which is the fluid analyzer described elsewhere herein. A borehole tool 20 is suspended in the borehole 12a from a lower end of a wireline or borehole tubing 22. The wireline or borehole tubing 22 may be operationally and electrically coupled to the fluid sampling system 16a and the fluid analyzer 18a. The borehole tool 20 comprises a body which encases a variety of electronic components and modules, which are schematically represented in FIG. 1B, for providing necessary and desirable functionality to the borehole tool 20.

The fluid analyzer 18a of the presently claimed and disclosed inventive concept(s), in its various embodiments, may preferably include a control processor (not shown) which is operatively connected with the borehole tool 20 and/or fluid analyzer 18a of the presently claimed and disclosed inventive concept(s). Preferably, certain methods the presently claimed and disclosed inventive concept(s) are embodied in a computer program that runs in or is associated with the fluid analyzer 18a. In operation, the program may be coupled to receive data, for example, via the wireline 22, and to transmit control signals to operative elements of the borehole tool 20.

The computer program may be stored on a computer usable storage medium associated with the processor (not shown), or may be stored on an external computer usable storage medium and electronically coupled to a processor for use as needed. The storage medium may be any one or more of presently known storage media, such as a magnetic disk fitting into a disk drive, or an optically readable CD-ROM, or a readable device of any other kind, including a remote storage device coupled over a switched telecommunication link, or future storage media suitable for the purposes and objectives described herein.

As noted, the gas or liquid chromatograph comprising the micro-scale column of the presently claimed and disclosed inventive concept(s) is preferably adapted for surface use at a well-site (FIG. 1A) or may be contained within a downhole tool adapted to drill or survey the wellbore and which is operatively connected to a rig via a drill string, pipe line or wireline. The downhole drilling tool may comprise a wellbore survey tool, a downhole communication unit, a rotary steerable system, a measurement-while-drilling system, a logging-while-drilling tool, a testing tool, and/or a sampling tool.

The downhole tool may also be provided with a downhole communication network for establishing communication between the various downhole components and can be formed by any suitable type of communication system, such as an electronic communication system, or an optical communication system. The electronic communication system can be either wired or wireless, and can pass information by way of electromagnetic signals, acoustic signals, inductive signals, and/or radio frequency signals.

As noted elsewhere herein, the micro-scale separation column disclosed herein may also be part of a downhole tool which can be any type of deployable tool capable of performing formation evaluation or surveying in a wellbore such as a wireline tool, a coiled tubing tool, a slick line tool or other type of downhole tool. The downhole tool may be a conventional wireline tool (except for the addition of the apparatus of the presently claimed and disclosed inventive concept(s) or as described elsewhere herein) deployed from the rig into the wellbore via a wireline cable and positioned adjacent to a subterranean formation. Examples of a wireline tool that may be used are described in U.S. Pat. Nos. 4,860,581 and 4,936,139.

The downhole tool may comprise modules such as testing modules, sampling modules, hydraulic modules, electronic modules, a downhole communication unit, or the like. The downhole communication unit can be a telemetry unit, such as an electromagnetic or mud pulse unit, or a wireline communication unit, an acoustic communication unit, or a drill pipe communication unit. In general, the downhole communication unit is linked to and utilized with a surface unit for retrieving and/or downloading information to the surface unit.

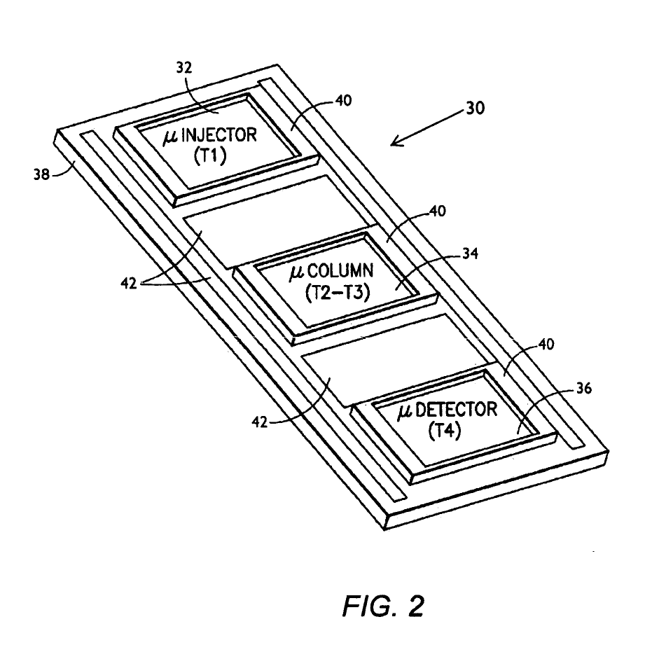

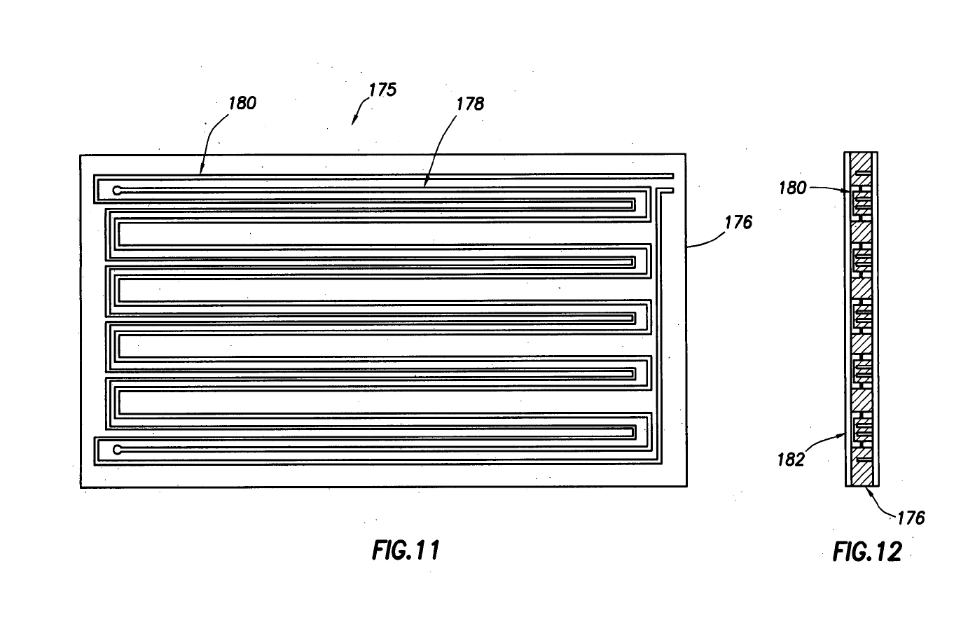

A micro-scale chromatography architecture contemplated for use in the presently claimed and disclosed inventive concept(s) can provide major advantages for effective thermal management. For example, the small size of micro-scale components equates to lower thermal mass. This makes temperature control of the components easier because there is a lower mass to be heated and/or cooled. According to one embodiment, the management of temperature transitions between components of the injector, column and detector may be controlled by incorporation of thermal stops and traps, as shown in FIG. 2 which illustrates a MEMS micro-scale fluid analyzer 30 the presently claimed and disclosed inventive concept(s) which comprises micro-fabricated components including a micro-injector 32, sputtered separation phase micro-column 34 and micro-detector 36 coupled to a micro-fluidic platform 38 and optionally including thermal stops 40 and thermal traps 42. A thermal stop is a heated extra mass, sized to preserve the stability of temperature at the perimeter of the heated micro-device. A thermal trap, on the other hand, is a void filled with thermal insulator that limits heat transfer and thus heat loss from the isolated component. Each component 32, 34, 36, and 38 of the micro-scale fluid analyzer 30 may be provided with a heater (not shown) that may set a desired temperature, or provide a ramped temperature, for each component. Using the thermal stops 40 and thermal traps 42, the uniformity of temperature within the heated components may be independently preserved. The heaters may be, for example, ceramic heaters or Peltier devices. Peltier devices may be formed as a flat plate that may fit between a chromatography component and the micro-fluidic platform, as illustrated below, for example, in FIGS. 11A-11C. Peltier devices have the property that when electricity is supplied, one side of the device heats up while the other side cools down. Thus, by providing a controlled supply of electricity to a Peltier device, local heating and/or cooling may be provided for each chromatography component. For example, the injector 32 may be operated at a first temperature, T₁, the column 34 operated over a range of temperatures, T₂-T₃, and the detector 36 operated at a third temperature, T₄. These different temperatures may be maintained at the individual devices by using the heaters together with the thermal traps 42 and thermal stops 40 to isolate the components 32, 34, and 36 from one another. With all or at least some of the chromatography components being at the microscale, such thermal management may be intrinsically easier to achieve.

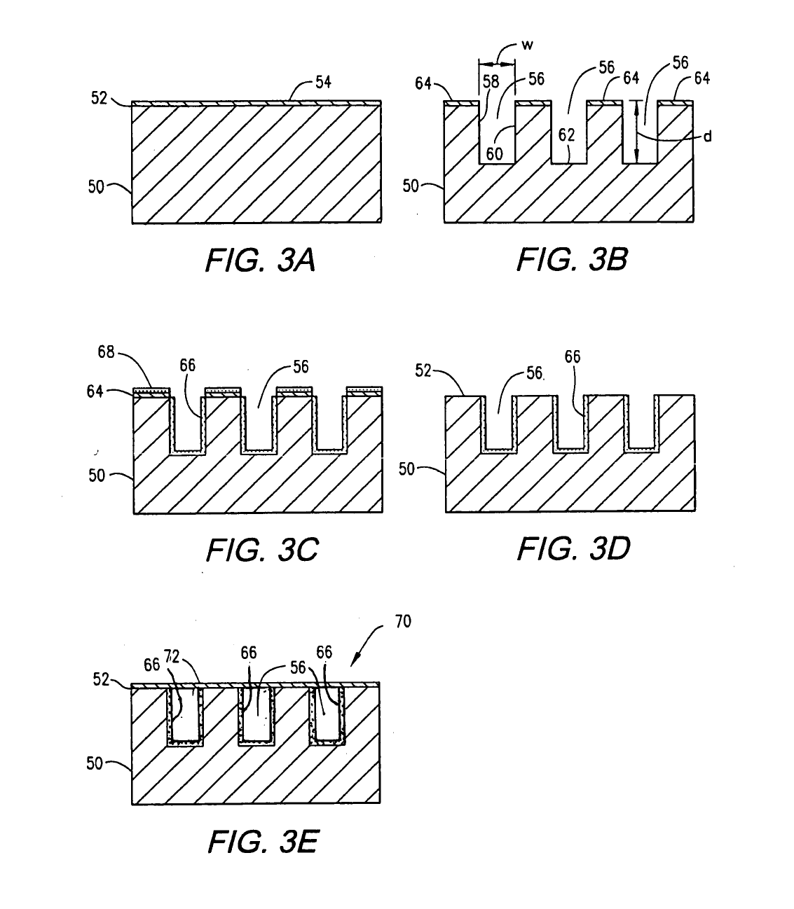

Described below is one embodiment of a micro-fabrication process for a sputtered coated MEMS column of the presently claimed and disclosed inventive concept(s), with examples of final devices and demonstrations of the retention capabilities for fluid analysis and separation of hydrocarbons such as hexane, alkanes smaller than hexane (C₁-C₅), and even alkanes heavier than hexane (C₉ and C₁₂). FIG. 3 is exemplary of the different steps of the micro-fabrication process to make the sputter-coated column of the presently claimed and disclosed inventive concept(s). A substrate (also referred to herein in certain embodiments as a “wafer”) 50 having an upper surface 52 is provided. Examples of substrate materials which may be used are described elsewhere herein. A photoresist material is spin-coated onto the upper surface 52 to form a photoresist layer 54 thereon. Photoresist materials and their application are known in the art thus further discussion thereof is not considered necessary herein. Photolithography and Deep Reactive-Ion Etching (DRIE) or an equivalent technique is then used for the anisotropic etching of micro-channels 56 (FIG. 3B) in a predetermined pattern. Each micro-channel 56 has a first side wall 58, a second side wall 60 and a bottom 62 (all of which may be referred to herein as “inner walls”). Residual portions 64 of the photoresist layer 54 are left after the etching process. Each micro-channel 56 has a depth “d” which is preferably in a range of from 5 micrometers to 500 micrometers and a width “w” which is preferably in a range of from 5 micrometers to 5000 micrometers. More specifically, the depth “d” and width “w” each may range from, but is not limited to, 5-10 μm, 10-20 μm, 20-40 μm, 40-60 μm, 60-80 μm, 80-100 μm, 100-150 μm, 150-250 μm, 250-500 μm, 500-1000 μm, to 1000-5000 μm.

Processes such as DRIE for micro-fabricating micro-scale channels, micro-valves, and other components in wafers such as silicon-on-insulator wafers are known to persons having ordinary skill in the art, thus extensive discussion herein of such processes and techniques is not considered to be necessary herein, however, description of such techniques can readily be found for example in U.S. Published Application 2008/0121017, for example in paragraphs 101-108 thereof. One or more stationary phase materials including, for example, but not limited to, silica, alumina and graphite or other materials noted elsewhere herein are then sputtered onto the etched forming a stationary phase sputtered coating 66 having a total thickness that typically varies within, but is not limited to, a range of from 1 to 5000 nm (FIG. 3C). The stationary phase sputtered coating 66 is formed on the side walls 58 and 60, and bottom 62 of the micro-channel 56. A sputtered coating 68 is also deposited upon the residual photoresist portions 64. The substrate 50 may then be sonicated in acetone for 5 to 10 minutes to remove the residual photoresist portions 64 and sputtered coating 68 thereon (FIG. 3D). After the photoresist material 64 is removed, the last step, FIG. 3E, of the process includes the anodic bonding of a cover 72 to the processed substrate 50. The cover 72 may be for example a Pyrex wafer and once bonded forms a sealed MEMS column 70. The thickness of the stationary phase sputtered coating 66 is preferably in a range of from 1 nm to 5000 nm.

Where used herein to refer to the thickness of the stationary phase coating 66 within the micro-channel 56 of the micro-fabricated column 70, the terms “uniform,” “uniformly,” or “uniformity” are intended to mean that the thickness of the sputtered coating 66 in the micro-channel 56 is substantially constant from the entrance of the column to the exit of the column on a particular inner wall surface (e.g., side wall 58 or 60, or bottom 62). For example the thickness preferably is relatively constant within a range of plus or minus 10% to 95% of an average of the thickness of the sputtered coating 66. For example, if the average thickness of the sputtered coating 66 on side wall 58 or 60, or bottom 62, is 100 nm, a measurement of the thickness of the sputtered coating 66 at any specific position on the sidewall 58 or 60, or bottom 62, of the micro-channel 56 will be between 5-195 nm, but is more preferably in a range of ±25%, that is between 75-125 nm for a coating having an average thickness of 100 nm.

The width “w” and depth “d” of the micro-channel 56 are each substantially uniform along the length of the micro-channel 56, that is, from the entrance to the exit thereof. The length of the micro-channel 56 from the entrance to the exit thereof is preferably in the range of 1 cm to 0.5 m to 5 m, and more preferably is at least 1 m in length. More specifically, the length of the column ranges from, but is not limited to, 1-5 cm, 5-10 cm, 10-15 cm, 15-20 cm, 20-30 cm, 30-50 cm, 50-100 cm, 100-500 cm, to 500-1000 cm. Similarly, the thicknesses of the sputtered coating 66 on the side walls 58 and 60 are substantially uniform along the length of the microchannel 56 as discussed above. Further, the thickness of the sputtered coating 66 on the bottom 62 of the micro-channel 56 is substantially uniform along the length thereof as discussed above, although the average thickness of the sputtered coating 66 on the bottom surface 62 may differ from the average thickness of the sputtered coating 66 on the side walls 58 and 60. For example, the average thickness of the sputtered coating 66 will generally be greater than the average thickness of the sputtered coating 66 on the sidewalls 58 and 60.

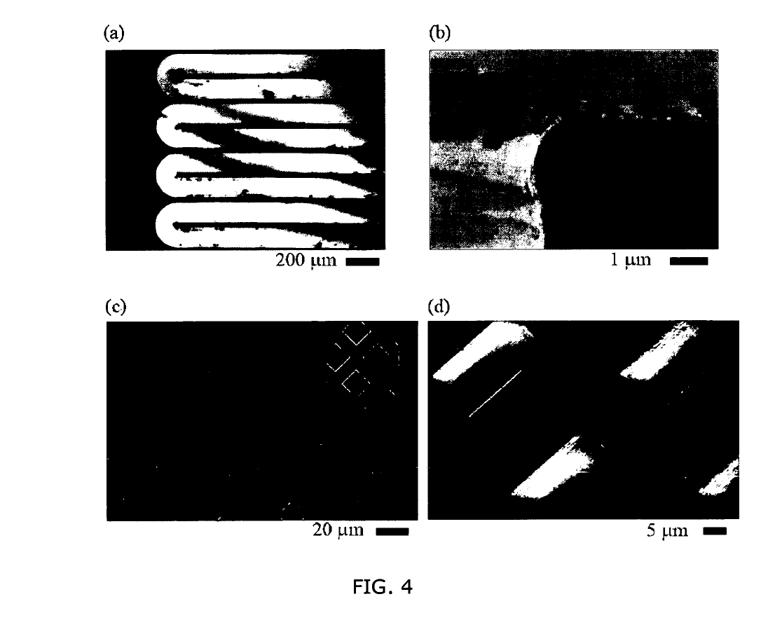

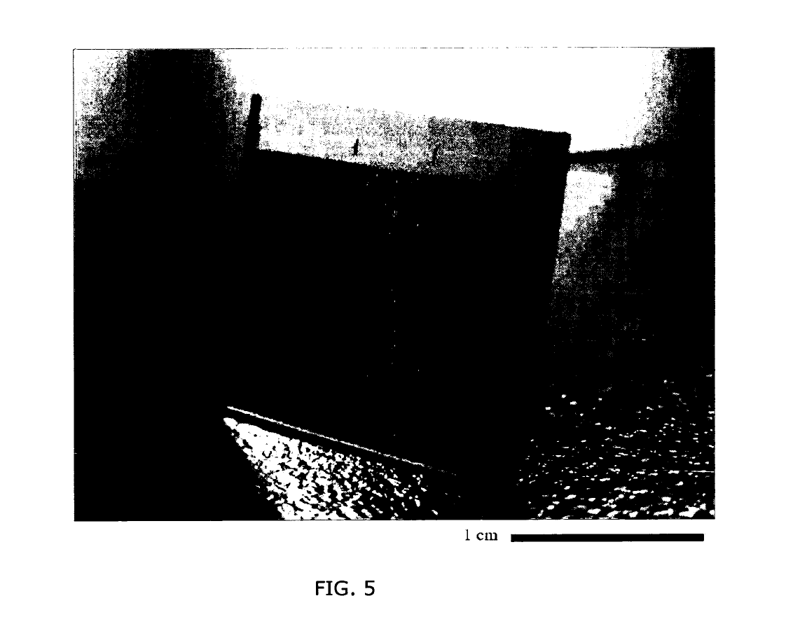

FIGS. 4(A-D) and 5 give examples of SEM pictures of micro-channels of micro-columns after the sputtering process. Those pictures show sputtered-silica coatings over horizontal and vertical surfaces of columns comprising micro-channels (FIG. 4A, B) and micro-structures (micro-pillars) of the micro-channels (FIG. 4C, D) following sputtering of the silica. Micro-pillars, where present in the column, may have widths which range from, but are not limited to, 1-5 μm, 5-10 μm, 10-20 μm, 20-40 μm, 40-60 μm, 60-80 μm, to 80-100 μm. The space between the pillars may range from, but is not limited to, 1-5 μm, 5-10 μm, 10-50 μm, 50-100 μm, to 100-500 μm. FIG. 5 shows an entire silica-coated MEMS column after the sputtering process.

It is preferred that the sputter coatings of the presently claimed and disclosed inventive concept(s) be characterized as having pores or corrugations such that the surface area of the sputtered coating is greater than the surface area of the micro-channel surface which is coated by the stationary phase material. Porosity can be controlled, for example, by alterations in the conditions used in the sputtering process, such as, but not limited to, temperature, pressure, gas flow, deposition time and power. In certain embodiments of the presently claimed and disclosed inventive concept(s), surface area of the sputtered coating may be in a range of from 5 to 1000 m²/g, for example. Diameters of pores in the sputtered coating may be in a range of from 1 to 1000 nm, for example.

The stationary phase material may be functionalized by chemical or thermal treatment. Generally speaking, the sputtered material can have on its surface some functional groups that can be chemically/thermally modified. Silica for example is known to have Si—OH groups that can be changed to Si—O—Si group. Chemical or thermal treatment can help to change the nature of the chemical groups on the surface, thereby impacting (“tuning”) the interactions between the fluid molecules and the sputtered coating. For example, thermal treatment may be used to regenerate active adsorption sites already occupied (for example by water molecules). Chemical treatments may be used to add other chemical groups on the stationary phase surface.

When the sputtered stationary phase is porous, the carrier fluid can penetrate into the depth of the stationary phase. In place of, or in addition to chemical or thermal treatment, the presently claimed and disclosed inventive concept(s) also contemplates fabrication of a stationary sputtered coating made of several thin layers of different sputtered materials. For example a stationary phase coating could be made of 100 nm or silica, 100 nm of graphite, 100 nm of alumina, in one or more separate additions, for example each 3 layers, then another 3 layers and so on (or two, or four alternating materials, for example).

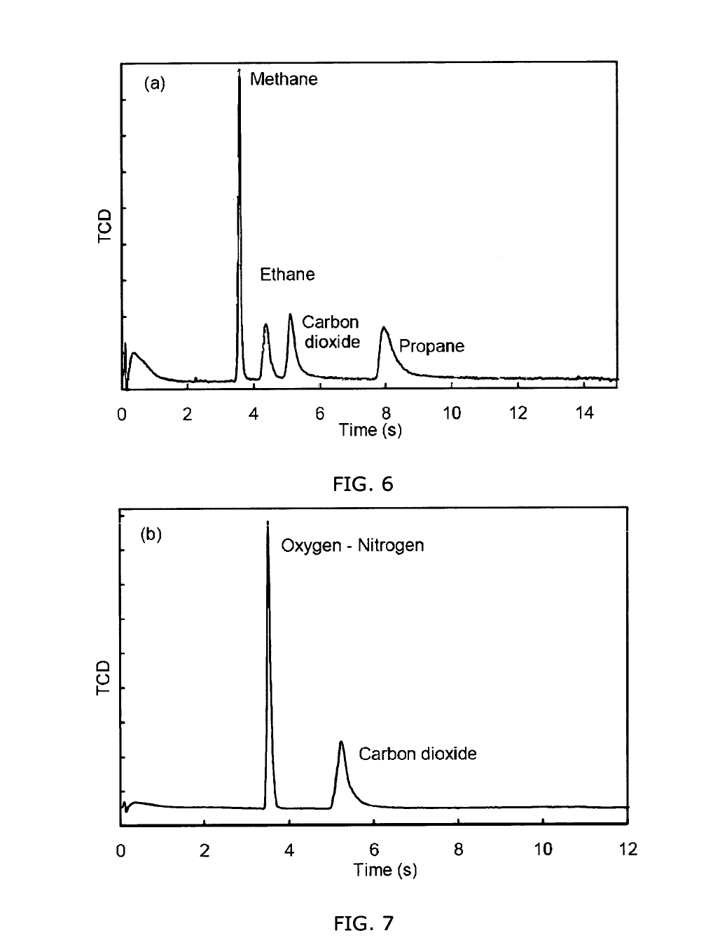

As noted above, the separation columns of the disclosure have the ability to separate hydrocarbon fluids below hexane (C₁-C₅), which are especially of interest for the analysis of natural gases. FIG. 6 shows an example of an isothermal separation of a methane, ethane, propane and CO₂ mixture using the sputter coated MEMS column of the presently claimed and disclosed inventive concept(s), wherein separation was obtained in less than 10 seconds. FIG. 7 shows an example of isothermal separation of a N₂/O₂—CO₂ mixture using the sputter coated MEMS column of the presently claimed and disclosed inventive concept(s). It should be understood that the separation of such mixtures may be performed under thermal ramping conditions, if desired.

As noted elsewhere herein, an important advantage the presently claimed and disclosed inventive concept(s) is the significant improvement obtained in the separation of components of natural gas versus that obtained using stationary phases and column configurations conventionally known and available to those of ordinary skill in the art. In particular, the presently claimed and disclosed inventive concept(s) optimizes the separation of methane, carbon dioxide, ethane, propane, butane, pentane and O₂/N₂ mixtures. The retention times of these compounds are substantially lower than that of C₆ compounds (hexanes) and higher. Generally, compounds with low retention times elute more quickly from the stationary phase thus reducing the efficiency of separation between the “peaks” of the constituents. Thus, for example methane and ethane may have lower retention times than CO₂, which has a lower retention time than propane, which has a lower retention time than butanes, which has a lower retention time than pentanes in general. As shown herein in FIGS. 6 and 7, the sputtered stationary phase column the presently claimed and disclosed inventive concept(s) is able to cleanly separate methane, CO₂, ethane, propane, butane and pentane components from each other and from higher alkanes, such as C₉ and C₁₂, present in natural gas.

Further, in a preferred embodiment of the presently claimed and disclosed inventive concept(s) the C₁-C₅ alkanes and CO₂ components of natural gas are separated by Resolution factors (“R”) of >1.5, or >2.0, or more preferably >2.5, or still more preferably >3.0 or >3.5, and yet more preferably >4.0, where R is the ratio of (1) the distance between the maxima of two peaks, and (2) the average of the base widths of the two peaks. Generally where R<=1.5, there is some overlap between the two peaks.

As explained above, the micro-fabricated sputtered stationary phase column of the presently claimed and disclosed inventive concept(s) can be used as a component of a chromatograph which is used as a component of a borehole tool (or borehole tool string) connected to a wireline for use in downhole analysis of formation fluids such as natural gas and other fluids such as petroleum. Provided below is further description of various embodiments of the chromatograph of the presently claimed and disclosed inventive concept(s).

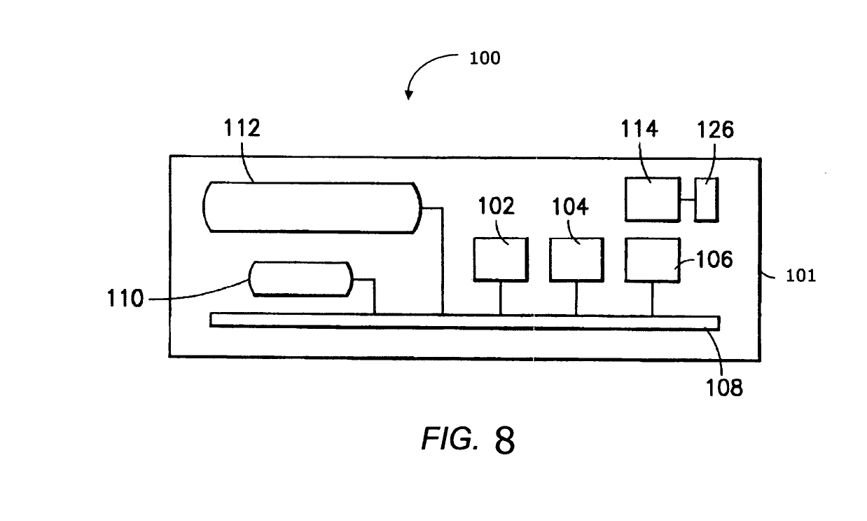

Referring now to FIG. 8, there is illustrated in a block diagram and designated therein by the general reference numeral 100 one embodiment of a chromatography system for use either in a surface application (such as at a well-site) or in a borehole tool 16 according to the presently claimed and disclosed inventive concept(s). The chromatography system 100 may comprise a plurality of components contained within a housing 101. These components may include, for example, an injector 102, one or more chromatography columns 104 such as the sputtered stationary phase columns of the presently claimed and disclosed inventive concept(s) and one or more detectors 106. These components are collectively referred to as chromatography components and are described further below. These components may be coupled to one another either directly or via a micro-fluidic platform 108 which is also discussed further below. In addition, the chromatography system 100 may include a power supply 126 and control components 114. In one example, the power supply 126 may include a wireline (such as wireline 18 described above) that may connect the chromatography system 100 to an external source of power (e.g., a generator or public electricity supply). In another example, particularly where several of the chromatography components may be micro-scale components, the power requirements may be sufficiently minimal to allow battery operation and the power supply 126 may thus include one or more batteries. These batteries may be, for example, Lithium Thionyl Chloride batteries rated for high temperature environments. In yet another example, the chromatography components may be powered via a USB connection to a computer, where information and data may also be exchanged.

As discussed above, the chromatography system 100 may also include a carrier fluid supply 110 as well as a waste storage component 112. Having an on-board carrier fluid supply 110 may allow the chromatography system 100 to be operated downhole (or in another remote environment) without requiring connection to an external supply of the carrier fluid. In a downhole or other pressurized environment (e.g., deep underwater locations or outer space), it may be difficult, if not impossible, to vent waste fluids outside of the chromatography system 100 due to high ambient pressure or other conditions, such as environmental concerns. Therefore, the on-board waste storage component 112 may be particularly desirable. By making at least some of the system components micro-scale components, a chromatography device small enough to comply with the space constraints of downhole environments may be realized.

It is to be appreciated that although embodiments of chromatography systems of the presently claimed and disclosed inventive concept(s) may be referred to herein as micro-scale systems, not all of the components are required to be micro-scale and at least some components may be meso-scale or larger. This is particularly the case where the device is intended for use in environments where the space constraints are not as tight as for downhole applications. As used herein, the term “micro-scale” is intended to mean those structures or components having at least one relevant dimension that is in a range of about 100 nm to approximately 1 mm. In order to achieve these scales, manufacturing technologies such as silicon micro-machining, chemical etching, DRIE and other methods known to those skilled in the art may be used. Thus, for example, a “micro-scale” chromatography column 104 is preferably constructed using a substrate (such as, but not limited to, a silicon wafer) into which are etched or machined very small channels of the micrometer-scale width. Although the overall length of such a column 104 may be a few centimeters, (in width and/or length), a relevant feature, namely, the channels, are not only micro-scale, but also may be manufactured using micro-machining (or chemical etching) techniques. Therefore, such a column may be referred to as a micro-scale column. Such columns have very low mass when packaged and therefore allow for easier thermal management compared to traditionally packaged columns. By contrast, “meso-scale” components of a chromatograph, e.g., an injector and/or detector, may have relevant dimensions that may be between several micrometers and a few millimeters and may be made using traditional manufacturing methods such as milling, grinding, glass and metal tube drawing etc. Such components tend to be bulkier than components that may be considered “micro-scale” components.

As discussed above, a chromatography system 100 according to embodiments of the presently claimed and disclosed inventive concept(s) may comprise an injector 102, at least one column 104 and at least one detector 106 interconnected via a micro-fluidic platform 108. The micro-fluidic platform 108 may include flow channels that provide fluid connections between the various chromatography components, as discussed further below. It is to be appreciated that various embodiments of the chromatography system 100 may include one or more columns 104 that may be disposed in a parallel or series configuration. In a parallel configuration, a sample may be directed into multiple columns 104 at the same time using, for example, a valve mechanism that couples the columns 104 to the micro-fluidic platform 108. The output of each column 104 may be provided to one or more detectors 106. For example, the same detector 106 may be used to analyze the output of multiple columns 104 or, alternatively, some or all of the columns 104 may be provided with a dedicated detector 106. In another example, multiple detectors 106 may be used to analyze the output of one column 104. Multiple detectors 106 and/or columns 104 may be coupled together in series or parallel. In a series configuration of columns 104, the output of a first column 104 may be directed to the input of a second column 104, rather than to waste. In one example, a detector 106 may also be positioned between the two columns 104 as well as at the output of the second column 104. In another example, a detector 106 may be positioned only at the output of the last column 104 of the series. It is to be appreciated that many configurations, series and parallel, are possible for multiple columns 104 and detectors 106 and that the presently claimed and disclosed inventive concept(s) is not limited to any particular configuration or to the examples discussed herein.

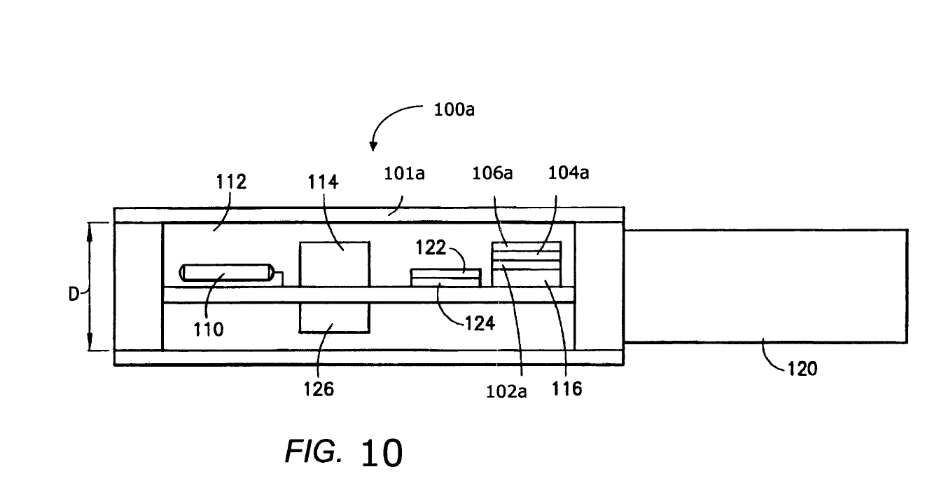

In one embodiment of a micro-scale chromatograph 100, some or all of the chromatography components may be MEMS devices. Such devices are small and thus appropriate for a system designed to fit within the small housing 101 of chromatograph 100 suitable for well-site surface use, or even downhole deployment. In addition, such devices may be easily coupled to the micro-fluidic platform 108. In one example, some or all of the three components 102, 104 and 106 may be MEMS devices that are approximately 2 cm by 2 cm by 1-2 mm thick. Arranged linearly, as shown, for example, in FIG. 10, these devices could easily be housed within a cylinder having an inner diameter of about 2 inches or less and a length of about 4 inches. However, it is to be appreciated that the injector 102, column 104 and detector 106 need not be discrete devices and also need not be linearly arranged within the housing 101. For example, the components 102, 104, and 106 could all be on a single microchip. Many other configurations are also possible and are considered included in this disclosure. In addition, many variations on the size and thickness of the devices are also possible and the presently claimed and disclosed inventive concept(s) is not limited to the specific example given herein.

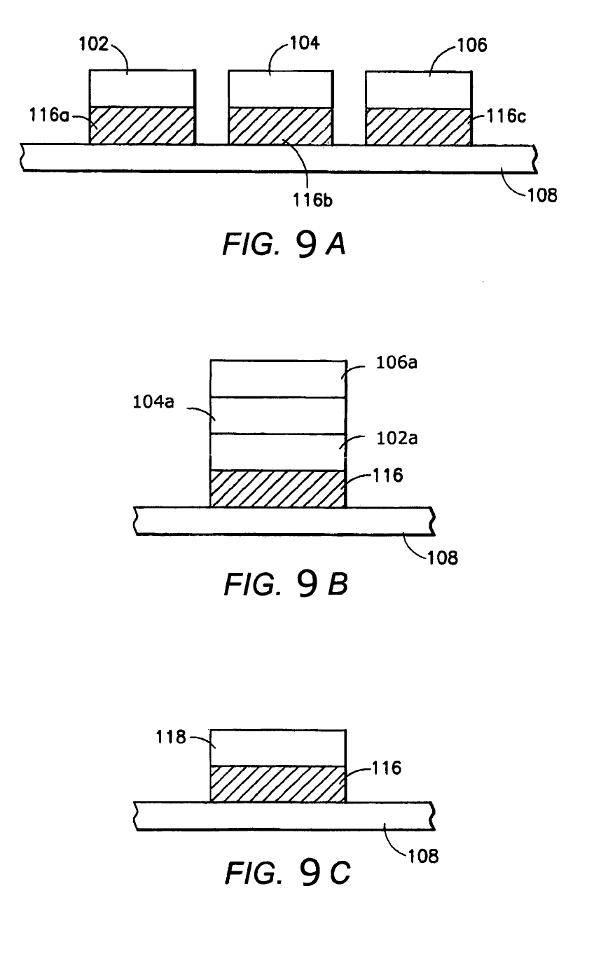

For example, referring to FIGS. 9A, 9B and 9C, there are illustrated three examples of arrangements of the injector 102, column 104 and detector 106. In FIG. 9A, the chromatography components are illustrated in a linear arrangement, similar to that shown in FIG. 8. Such a linear configuration may be advantageous when it is desirable to keep the inner diameter of the housing 101 as small as possible and where the length of the housing 101 is less critical. This configuration may also have the advantage of allowing each discrete device 102, 104 and 106 to have individual thermal management device including, for example, individual heating devices 116a, 116b, and 116c, respectively, as shown. Therefore, this linear configuration may be preferred in application where the injector 102, column(s) 104, and detector(s) 106 are to be operated at different temperatures. In the example illustrated in FIG. 9A, the heating elements 116a-116c are shown positioned between the respective components 102, 104 and 106 and the micro-fluidic platform 108; however, it is to be appreciated that the presently claimed and disclosed inventive concept(s) is not limited to the illustrated arrangement. For example, referring to FIG. 9B, an injector 102a, a column 104a and a detector 106a are illustrated in a stacked arrangement, one on top of the other with a heating device 116 disposed thereunder. Such a stacked arrangement may be preferable if there is a need or desire to shorten the length of the housing 101. For example, the stacked components, along with other components making up the chromatograph system, may fit within a housing having an inner diameter of less than about 2 inches and a length of about 1.5 inches. In another embodiment, illustrated in FIG. 9C, integrated MEMS device 118 may contain an injector, column and detector disposed upon a heating device 116. In one example, such an integrated MEMS device may be less than about 2 cm by about 5 cm by about 1 to 2 mm in height. The stacked and integrated embodiments shown in FIGS. 9B and 9C may be particularly suitable for isothermal analysis where all active components are held at the same temperature. In these examples, one heater 116 may suffice for all of the injector, column and detector components.

According to one embodiment, and referring again to FIG. 8, a micro-scale chromatograph 100 according to aspects of the presently claimed and disclosed inventive concept(s) may comprise one or more components at the micro-fluidic scale, wherein the flow channels are very small. For example, in one embodiment, the flow channels may be on the order of about 1 μm-1000 μm and more preferably 5 μm-100 μm. Volumetric flow rates of carrier fluid through the flow channels scale approximately as the square of the effective diameter of the channel. Therefore, a micro-scale chromatography system 100 may inherently require a significantly smaller supply of carrier fluid when compared to a meso-scale or larger scale system. In one example, a micro-scale chromatography apparatus may consume carrier fluid at a rate 5 or even 10 times slower than a traditional, larger chromatography system that includes much larger flow channels. This may be advantageous in that both the carrier fluid supply 110 and waste storage component 112 (see FIG. 8) may be comparatively smaller as they may contain a smaller volume of the carrier fluid. For example, assuming that the carrier fluid consumption for a micro-scale chromatograph 100 is on the order of about 100 microliters per minute (μL/min), for a 1000-minute service downhole, 100 milliliters (mL) of carrier fluid may be required. Assuming that the analysis is performed at near-atmospheric pressure (approximately 15 psi), a waste storage container 112 of about 100 mL would be needed. In one embodiment, the carrier fluid supply may be stored in a high pressure (e.g., about 1000 psi) container 110 and thus, the size of the container 110 may be extremely small. The carrier fluid used with the micro-injector may be any fluid used by persons of ordinary skill in the art of sample analysis, including, but not limited to, gases such as nitrogen, helium, argon, H₂, CO₂ (where it is not a component desired to be measured in a sample), air, in some embodiments liquids such as alcohols, polar and non-polar solvents, other hydrocarbons, and sterile H₂), for example, may be used as a carrier fluid in place of a gas when the MEMS device is used with liquid chromatography. In another example, more than one carrier fluid, carrier fluid supply, and waste storage container may be used (particularly when the MEMS device is used with liquid chromatography) for applications where a mixture of solvents and/or a change in ratio are useful during the analysis.

When the MEMS device described herein is used for liquid chromatography, e.g., for hydrocarbon liquid analysis, the preferred technique among the different liquid chromatography techniques is HPLC (High Performance Liquid Chromatography) normal phase liquid chromatography although use of the MEMS device in the reverse phase mode is also contemplated. The MEMS column designed for liquid chromatography would preferably contain a very dense network of micropillars in order to mimic the packing classically used in LC. The stationary phase would preferably be functionalized but may not be functionalized.

When used in liquid chromatography, the carrier fluid is generally passed through the micro-column at a pressure of from 1 to 1000 bars, and preferably of from 100 to 200 to 300 to 400 to 500 to 600 bars.

Referring now to FIG. 10, there is illustrated therein a block diagram of another embodiment of a chromatography apparatus 100a according to the presently claimed and disclosed inventive concept(s). In this embodiment, an injector 102a, column 104a and detector 106a are shown in a stacked arrangement (e.g., as in FIG. 9B), one on top of the other. However, it is to be appreciated that any of the above-mentioned configurations of FIG. 9A-9C may be used. Also shown are some thermal management components including the heater(s) 116 discussed above and a cooler 120. These components are discussed in more detail below. In the illustrated embodiment, a housing 101a contains the chromatography components, the micro-fluidic platform 108, carrier fluid container 110 and other components, may also serve as the waste storage container 112. This may eliminate the need for a separate waste storage container which may reduce the overall size of the system. In one example of this embodiment, the housing 101a may be a cylinder that has an inner diameter D of about 2 inches and a length of about 8 inches.

According to some embodiments of the presently claimed and disclosed inventive concept(s), a chromatography system 100a may also include a sampler 122. Before a gas or fluid to be analyzed (referred to herein as a “formation fluid”) can be introduced into the chromatography apparatus 100a, a sample of the formation fluid may be extracted from its environment (e.g., from a rock formation in the case of boreholes). Thus, a self-contained chromatography system 100a may include the sampler 122 to perform this extraction/sampling. In downhole environments, the formation fluid may be at high pressure (e.g., about 20 kpsi) and high temperature (up to about 200° C. or even higher). Traditional chromatographic methods require that the sample be de-pressurized, while carefully modulating its temperature to control the separation process. According to one embodiment, a micro-scale sampler 122 can optionally be integrated into the chromatography apparatus 100a. The sampler 122 may be coupled to a heater 124 to achieve at least some temperature modulation. In one example, the sampler 122 may be a multi-stage sampler and phase separator. In this example, the sampler 122 may perform phase separation to eliminate water, which can deteriorate chromatographic analysis. Being at the micro-scale, the sampler 122 may then isolate a minute quantity of formation fluid, for example, in the sub-microliter or sub-nanoliter range. Depressurization may be accomplished in an expansion chamber accompanied by appropriate temperature control to preserve the sample elution. The chromatography system 100a may comprise other components known in the art such as are shown in U.S. Published Patent Application 2008/0121017.

A chromatograph generally benefits from precise control and manipulation of the temperature of its major components. As discussed above, in chromatography, separations occur as a sample moves through the column and the time taken for components of the sample to exit the column depends on their affinity to the stationary phase. This affinity has a strong dependence on temperature and therefore, the temperature of the column may need to be very accurately controlled. Some components separate more effectively at low temperatures, whereas other components separate more effectively at high temperatures. Therefore, the temperature of the separation column may need to be controlled to temperatures below the ambient environmental temperature, particularly for downhole operation where the ambient temperature may be 200° C. or higher. Accordingly, a cooling device may be needed to maintain a desired temperature of the separation column. In addition, some analyses may involve heating the separation column with a fast and well-defined increasing temperature ramp. After a sample analysis is completed, the separation column may be cooled to the lower starting temperature. Thus, in some examples, the separation column may need to be heated and cooled cyclically for each analysis. The rate of heating may need to be fast for certain applications, while the rate of cooling preferably may be as fast as possible to minimize lag time between successive analyses. The cooling process can be particularly time consuming unless a cooling mechanism, such as a fan or other cooling device, is provided. However, both the heating apparatus and the cooling apparatus may contribute to the total thermal mass of the chromatography device. In general, increasing the thermal mass may make the heating, and particularly the cooling, functions slow and inefficient.

In addition to controlling the temperature of the separation column, the temperatures of other components, for example, the injector and/or the detector may also need to be controlled. Furthermore, different components may need to be maintained at different operating temperatures from one another. For example, some analyses may require temperature ramping of the separation column while holding the injector and detector at a constant temperature. Also, the temperature distribution throughout the separation column, including its inlet and outlet, may preferably be uniform to maintain the quality of chromatographic separation. In many circumstances, the injector and the detector, as well as the fluidic interconnections, may also preferably need to be held at a controlled temperature to avoid cold spots and uneven thermal distribution. In conventional large-scale chromatography systems, thermal management is challenging and may be particularly difficult at high ambient temperatures. Traditional heating and cooling devices may have high thermal mass, adding to the complexity of the thermal management. In addition, even “miniaturized” fluidic connections used in traditional chromatography apparatus have large enough thermal mass, that thermal management becomes difficult at best. This is particularly the case in a downhole environment where tool space is limited and it is difficult to eject heat from components and cooling apparatus due to the high ambient temperature. Accordingly, using a traditional approach to heating and/or cooling in a downhole tool can result in excessively long analyses times (due to slow, inefficient cooling) along with a complex and inefficient thermal management apparatus.

As discussed above, a particular chromatography component that may require or benefit from precisely controlled, flexible thermal management is the chromatography column. For example, as discussed herein, for some analyses, the column may be provided with a fast temperature ramp and/or may be quickly cooled between analyses to speed up data acquisition time. As discussed herein, a preferred chromatography column according to the presently claimed and disclosed inventive concept(s) is a MEMS device that includes a substrate, such as a silicon substrate, with a contiguous micro-channel column fabricated therein and coated with a stationary phase deposited by sputtering for chromatographic analysis. To achieve thermal management, the column may include integrated heating and/or cooling devices as discussed above. These devices may control the temperature of the column independent of the surrounding temperature of the overall chromatography system and other chromatography components within the system.

Referring to FIG. 11, there is illustrated a top view of one example of a geometry for a micro-scale chromatography column 175 of the presently claimed and disclosed inventive concept(s) as implemented as a microchip and including embedded heating and optional cooling. In the embodiment illustrated in FIG. 11, the micro-column 175 includes a substrate 176 such as any substrate described elsewhere herein. A contiguous column micro-channel 178 is fabricated in the substrate 176, for example, by etching or micro-machining, or as other methods described herein or known in the art and provides the flow pathway for the sample through the column 175. The micro-channel 178 has deposited thereon a stationary phase coating as previously discussed herein. Ports may couple the column micro-channel 178 to, for example, a microfluidic platform (as described earlier) or to another chromatography component (e.g., a detector or second column). A second contiguous channel comprising a heating channel 180 may be fabricated in the substrate 176 interleaved with the column micro-channel 178, as shown in FIG. 11. This heating channel 180 may contain a heating element (not shown). For example, the heating element may be a resistive wire (e.g., a metallic conductor coated with a dielectric insulator) that is laid inside the heating channel 180. Alternatively, a conductive (e.g., metallic) layer may be deposited on the heating channel 180 as well as optionally on other surfaces of the microchip. The heating element (e.g., conductive layer or resistive wire) may be coupled to the power supply 126 (see FIG. 8) such that the heating element may be electrically heated to heat the column.

Further, in a particular embodiment, a metallic coating may be sputtered on the inner walls of the micro-channels of the separation columns described herein prior to sputtering of the stationary phase material. The metallic coating which underlays the stationary phase coating thus may be coupled to the power supply such that the metallic coating (i.e., metallic undercoating) can serve as a heating element for heating the stationary phase material sputtered thereover. In another embodiment, a contiguous cooling channel 182 may be provided on the microchip (FIG. 12). In one embodiment, a cooling fluid may be provided in the cooling channel 182.

It is to be appreciated that the representative geometries shown in FIGS. 11 and 12 are for illustration only and are not intended to be limiting. Various other geometries are envisioned and may be apparent to those skilled in the art. For example, the cooling channel 182 may be provided on the same side of the microchip as the heating channel 180. In another example, the heating channel 180 may be provided on the reverse side of the microchip. In another example, either or both of the heating channel 180 and cooling channel 182 may comprise a plurality of channels, rather than a single contiguous channel. These and other modifications to the geometry that may be apparent to those skilled in the art are intended to be part of this disclosure. Furthermore, although not shown in FIGS. 11 and 12, the chromatography column may be provided with an optional low thermal mass heating device, such as a thermoelectric heating device as discussed above, in addition to the heating channel 180. In one example, such a heating device may include a low thermal mass thin-film Peltier device that may be attached to one or both sides of the microchip. The thin-film Peltier device may be approximately the same size as the microchip and may be used to provide heating and/or cooling to achieve a desired ambient or in the case of a ramped system, a desired starting temperature for the chromatography column, as discussed above. Embodiments of the micro-column thus may integrate a heater, an optional flow path for a cooling fluid, and a chromatography separation column in a MEMS device having very low thermal mass.

Alternatively, rather than supplying a coolant in the cooling channel(s) 182, cooling may be achieved using air convection. The heat from the column may be transported through the silicon and/or glass substrate to the chip surfaces, then carried away by air convection. For cooling by convection, cooling channels 182 may not be necessary; however, cooling channels 182 may increase the surface area of the microchip, thereby allowing for more efficient convective cooling.

In one example, silica was sputtered on a silicon wafer under conditions of 80 sccm (standard cubic centimeters per minute) of argon gas at 3 mTorr (i.e., 0.4 Pa) pressure, 600 W of power, over a period of 30 minutes at a silica volume rate of 50 nm/min. This produced a silica coating having an average thickness of about 1500 nm on horizontal surfaces and about 700 nm on vertical surfaces of the micro-channel of the column.

In general, the ionization gas, such as argon, can be provided for example under a pressure of 0.5 to 100 mT (i.e., 0.07 to 13.3 Pa), at a power level of 100 to 20,000 W, and over a deposition time of 1 to 1,000 minutes.

Shown in Table 1 in another example are experimental conditions used to apply a stationary phase coating of carbon provided by sputtering of a graphite material. As indicated by the results, an increase in power level increased the thickness and volume of the sputtered layer (Wafer No. 1 vs. Wafer No. 2) and an increase in deposition time further increased the thickness of the sputtered layer (Wafer No. 2 vs. Wafer No. 3).

TABLE I
Sputtering Conditions for Carbon Deposition

| Parameters | Wafer No. 1 | Wafer No. 2 | Wafer No. 3 |
|---|---|---|---|
| Argon Flow (sccm) | 80 | 80 | 90 |
| Pressure (mT) | 3 | 3 | 3 |
| Power Level (W) | 500 | 800 (1.6 A) | 800 (1.6 A) |
| Deposition time (min) | 10 | 10 | 40 |
| Measured Thickness (nm) | 63.5 | 134.7 | 510 |
| Rate of deposition (nm/min) | 6.35 | 13.47 | 12.75 |

Having now described some illustrative embodiments of the presently claimed and disclosed inventive concept(s), it should be apparent to those skilled in the art that the foregoing is merely illustrative and not limiting, having been presented by way of example for the purposes of clarity. Numerous modifications and other embodiments are within the scope of one of ordinary skill in the art and are contemplated as falling within the scope of the presently claimed and disclosed inventive concept(s). In particular, although many of the examples presented herein involve specific combinations of method steps or system elements, it should be understood that those steps and those elements may be combined in other ways to accomplish the same objectives. For example, the chromatographic systems and techniques of the presently claimed and disclosed inventive concept(s) can be implemented to analyze components other than natural gas in a variety of environments including but not limited to downhole environments.

Further, those skilled in the art should appreciate that the parameters and configurations described herein are exemplary and that actual parameters and/or configurations will depend on the specific application in which the systems and techniques of the presently claimed and disclosed inventive concept(s) are used. Those skilled in the art should also recognize or be able to ascertain, using no more than routine experimentation, equivalents to the specific embodiments of the presently claimed and disclosed inventive concept(s). It is therefore to be understood that the embodiments described herein are presented by way of example only and that, within the scope of the appended claims and equivalents thereto; thus the presently claimed and disclosed inventive concept(s) may be practiced otherwise than as specifically described herein.

Moreover, it should also be appreciated that the presently claimed and disclosed inventive concept(s) is directed to each feature, system, subsystem, or technique described herein and any combination of two or more features, systems, subsystems, or techniques described herein and any combination of two or more features, systems, subsystems, and/or methods, if such features, systems, subsystems, and techniques are not mutually inconsistent, is considered to be within the scope of the presently claimed and disclosed inventive concept(s) as embodied in the claims. Further, acts, elements, and features discussed only in connection with one embodiment are not intended to be excluded from a similar role in other embodiments. Rather, the systems and methods of the present disclosure are susceptible to various modifications, variations and/or enhancements without departing from the spirit or scope of the present disclosure. Accordingly, the present disclosure expressly encompasses all such modifications, variations and enhancements within its scope.

All patents, published patent applications and published articles or references mentioned herein including U.S. patent application Ser. No. 12/503,902, filed Jul. 16, 2009, and entitled “Gas Chromatograph column with Carbon Nanotube-Bearing Channel” are hereby expressly incorporated herein by reference in their entireties.

What is claimed is:

1. A method for micro-fabricating a stationary phase-lined chromatography channel, comprising the steps of:
providing a substrate;
preparing and etching a surface of the substrate to form an etched substrate having a fluid micro-channel having a wall surface;
assembling a coating layer of a stationary phase material on the wall surface of the fluid micro-channel, wherein the coating layer of a stationary phase material is substantially uniform in thickness along the length of the fluid micro-channel; and
disposing a cover over at least a portion of the surface of the etched substrate for enclosing at least a portion of the fluid micro-channel.

2. The method of claim 1, wherein the step of preparing and etching further comprises:
applying a photoresist material upon the surface of the substrate;
removing a portion of the photoresist material using photolithography; and
etching the fluid micro-channel in the substrate using a deep reactive ion etching process.

3. The method of claim 1 wherein the step of assembling the coating layer of a stationary phase material comprises sputtering the stationary phase material upon the wall surface of the fluid micro-channel.

4. The method of claim 1 wherein the substrate comprises silicon, glass, sapphire, gallium arsenide, and/or a Group III-IV material, and which is doped or undoped.

5. The method of claim 1 wherein the stationary phase material is at least one of silica, alumina, graphite, amorphous carbon, a zeolite, aluminosilicate, a porous polymer, and a salt.

6. The method of claim 1 wherein at least a portion of the fluid micro-channel is enclosed using a glass and/or silicon wafer.

7. A micro-scale chromatograph for separating components of a fluid, comprising:
an injector block for providing a fluid sample for separation into a plurality of components; a separation column for receiving the fluid sample, the separation column having an input to receive the fluid sample, a stationary phase comprising a sputtered coating of a stationary phase material, the sputtered coating disposed upon a surface of a fluid micro-channel in the separation column in a substantially uniform layer along the length of the fluid micro-channel, and an output through which is expelled the components of the fluid sample; and
a detector arranged to receive the components of the fluid sample from the output of the separation column.

8. The micro-scale chromatograph of claim 7 wherein the separation column is etched into a substrate comprising silicon, glass, sapphire, gallium arsenide, and/or a Group III-IV material, and which is doped or undoped.

9. The micro-scale chromatograph of claim 7 wherein the stationary phase material used to form the sputtered coating is at least one of silica, alumina, graphite, amorphous carbon, a zeolite, aluminosilicate, a porous polymer, and a salt.

10. The micro-scale chromatograph of claim 7 wherein the separation column has a fluid micro-channel length of at least 0.5 m.

11. The micro-scale chromatograph of claim 7 which is adapted for use on a well-site at or near a wellhead of a wellbore.

12. The micro-scale chromatograph of claim 7 comprising a metal layer disposed under the stationary phase coating.

13. The micro-scale chromatograph of claim 7 wherein the fluid is natural gas.

14. The micro-scale chromatograph of claim 7 comprising a liquid chromatograph apparatus.

15. The micro-scale chromatograph of claim 7 comprising a gas chromatograph apparatus.

16. A method for analyzing a fluid sample comprising a plurality of analytes having molecular masses lower than hexane, comprising the steps of:
disposing the micro-scale chromatograph of claim 7 in a position for receiving the fluid sample;
injecting the fluid sample into the micro-scale chromatograph wherein at least a portion of the plurality of analytes are separated by the coating layer of a stationary phase material in the separation column of the micro-scale chromatograph; and
detecting the portion of the plurality of analytes separated by the separation column as a function of time.

17. The method of claim 16 wherein the portion of the plurality of analytes separated by the separation column comprises at least two of methane, ethane, a propane, a butane, a pentane, carbon dioxide, oxygen, nitrogen and hydrogen sulfide.

18. The method of claim 16 wherein the fluid sample is analyzed at a surface location by positioning the micro-scale chromatograph in fluid communication with a sampling apparatus and/or a separator apparatus wherein the fluid sample is obtained from a fluid formation adjacent a wellbore.

19. The method of claim 16 wherein the fluid sample is analyzed downhole by disposing the micro-scale chromatograph within a wellbore and the fluid sample is obtained from a fluid formation adjacent the wellbore.

20. The method of claim 16 wherein the analytes separated in the separation column are separated by a resolution factor R>1.5.

21. The method of claim 16 wherein the stationary phase coating of the separation column is heated by passing an electric current through a metal layer disposed under the stationary phase coating.

22. The method of claim 16 wherein the fluid sample is injected into the micro-scale chromatograph with a carrier gas.

23. The method of claim 16 wherein the fluid sample is injected into the micro-scale chromatograph with a liquid carrier fluid.

24. A downhole tool for analyzing a fluid sample in a wellbore, the downhole tool comprising:
a housing operatively connected to a conveyable line;
the micro-scale chromatograph of claim 7 positioned in the housing; and
a communication link providing an operative communication between the micro-scale chromatograph of the downhole tool and a power assembly.

25. The downhole tool of claim 24 which comprises a drilling tool, a wireline tool, a tool string, a bottomhole assembly, or a well survey apparatus.
